(19) United States
(12) Patent Application Publication
(10) Pub. No.: US 2024/0371248 A1
(43) Pub. Date: Nov. 7, 2024

(54) Cycle Safety System

(71) Applicant: CAVs Guardian Limited, Thames Ditton, Surry (GB)

(72) Inventors: Neil Morgan, Harrow Middlesex (GB); Alex James Jadavji, Harrow Middlesex (GB)

(21) Appl. No.: 18/697,179

(22) PCT Filed: Sep. 30, 2022
(86) PCT No.: PCT/IB2022/059350

§ 371 Date: Mar. 29, 2024

(30) Foreign Application Priority Data
Sep. 30, 2021 (GB) 2114007.4

(51) Int. Cl. G08B 21/02; G08G 1/16

(52) U.S. Cl. CPC G08B 21/02; G08G 1/16

(57) ABSTRACT

A cycle safety system (100) comprising a cycle safety device (210), a vehicle safety device (310) and an alerting system (328). The cycle safety device (210) is shaped for insertion into a frame of the cycle (200) and comprises a transmitter (212) configured to transmit a signal advertising the presence of the transmitter (212). The vehicle safety device (310) comprises one or more receivers (312) configured to receive the signal advertising the presence of a transmitter and to communicate with the alerting system (328). At least part of the alerting system (328) is configured to be positioned adjacent to a driver's seat of a motor vehicle (300). The alerting system (328) is configured to indicate the presence of the cycle (200) to a driver of the vehicle (300) based on the communication from the one or more receivers (312).

### TECHNICAL FIELD

The present invention relates to a cycle safety system, a cycle safety device, a safety device, a method, a cycle, and a motor vehicle.

### BACKGROUND

Cyclists ride bicycles (bikes), motorcycles and scooters, for example, on the road. Cycle lanes are widely provided, but even so, cyclists are regularly injured through collisions with other vehicles. Drivers of commercial vehicles such as heavy goods vehicles (HGVs), with a cab that is higher off the ground than a car, for example, may have blind spots in their wing mirrors that mean they cannot readily see cyclists who may be riding (or stationary) alongside the commercial vehicle.

Commercial vehicles may include warning signs, for example at the rear, indicating that the driver of the vehicle may have blind spots (and therefore not be able to see passing cycles).

Cyclists often add reflectors or powered lights to their bikes, and wear bright clothing or reflective clothing, to help them be seen at night or in low light. Even so, they may be hard to spot for drivers of motor vehicles sharing the road. Bikes often include bells to allow the cyclist to indicate that they are approaching without relying on being seen, but these may be difficult for drivers of motor vehicles to hear (and are more useful for warning pedestrians). Bike horns are also known and may be used to indicate the presence of a cyclist.

Giving an HGV driver or another motor vehicle driver advance warning of a bike passing near their vehicle is a useful tool in protecting the cyclist and the driver. While the cyclist is more exposed in the event of a collision, the motor vehicle driver may also be endangered by a passing bike if the driver swerves to avoid the bike, for example, and finds themselves in danger on their new path or loses control of the vehicle. Both the cyclist and the driver of the motor vehicle can take action to reduce accidents, as both are put at risk in a collision.

It is known to associate a sensor with a bike and/or an HGV. The Cycle Alert TM system implements a cycle tag, side units (for an HGV) and a cab unit. The cycle tag is part of a cycle helmet or worn by the rider. When the bike is moving, the tag transmits a signal advertising its presence. The side units and cab unit determine the signal strength from the cycle tag and alert the driver with sound and visual alert, to show that a cyclist is near and the cyclist's position with respect to the HGV-right, left, front or rear.

The present invention seeks to address problems with the prior art.

### SUMMARY

Aspects of the present invention are set out in the appended claims. Optional features are set out in the dependent claims.

A first aspect of the present invention provides a cycle safety device for fitting to a cycle, the cycle safety device comprising a transmitter configured to transmit a signal advertising the presence of the transmitter, wherein the cycle safety device is shaped to fit into a frame of the cycle. Since the transmitter is intended to be located, in use, at a cycle, it is sometimes referred to herein as “a cycle transmitter”.

Bike seats normally comprise a saddle and a seat post; the seat post extends into a seat tube to a depth chosen by the cyclist so that their saddle is at a comfortable distance from the pedals. The seat post provides a place to house the cycle safety device within the frame of the cycle. The seat tube provides an alternative place to house the cycle safety device within the frame of the cycle.

The cross-section of a seat post is circular, as standard. The cycle safety device may have a generally circular cross-section to fit into a seat post or seat tube. The standard diameter of a seat post is 27.2 mm or 30.9 mm-31.6 mm. For BMX bikes, the standard diameter of a seat post is 25.4 mm. Other seat post diameters may be used, ranging from 22 mm to 35 mm, in 0.2 mm increments. Therefore, the cycle safety device may be shaped to fit into seat posts having a diameter between 22-35 mm. Seat tubes may be sized to accommodate seat posts of these sizes, accordingly. The cycle safety device may have a diameter of between 22-35 mm. For example, 25 mm or 30 mm. Where necessary the cycle safety device may be fitted externally to the cycle frame by means of a bracket designed to accommodate the cycle safety device. The bracket may attach via secure clips or may attach to the frame usually associated with cycle water bottles or tyre air pumps.

As noted, the cycle may be a motorcycle or scooter. In that case, the cycle safety device may be installed within the seat, for example, or elsewhere on the frame where using the seat post as easily as with a pedal/push bike is not an option.

The cycle safety device may comprise a printed circuit board (PCB) to connect the cycle transmitter electrically to other elements of the cycle safety device.

The cycle safety device may comprise a power source. For example, the cycle safety device may include a battery, for example a Lithium Thionyl Chloride battery. The battery may be selected based both on lifetime and physical size (to keep the device compact enough to fit into the seat post of a cycle, for example). A ½ AA or AA sized battery may be used. The cycle safety device could be powered by way of the cyclist pedalling the cycle, for a pedal bike, and the energy being stored and converted to electrical energy, for example.

For motorcycles or powered scooters, the cycle safety device may draw power from the power source of the powered bike as a main power source instead of batteries, or as a back-up power source, for example.

The cycle transmitter may comprise an ultra wide band transmitter as described in more detail below. When used in a cycle safety system of the type discussed below signals transmitted by the cycle transmitter may be received at a vehicle safety device, to indicate the presence of the cycle safety device to a driver of a motor vehicle in which the vehicle safety device is installed.

The cycle safety device may further comprise a second short range transmitter, such as a Bluetooth transmitter.

The cycle safety device may further comprise a motion sensor, wherein the cycle transmitter is configured to enter a powered state when the motion sensor determines that the cycle is moving and wherein the transmitter is configured to enter an unpowered state when the motion sensor determines that the cycle has been stationary for a predetermined period of time. The motion sensor may include an accelerometer.

The cycle safety device may have a plurality of operating modes, each of which may draw a different amount of power. In this way, the cycle safety device may enter lower and higher powers modes as necessary, to perform its task but also save power.

In one example, the cycle safety device may have four operating modes:
Idle Safe
Active Safe
Idle Recovery
Active Recovery

In one example, the cycle safety device may start in the Idle Safe mode, and when the cycle is moving (detected with the motion sensor, such as an accelerometer), the cycle safety device may become active and transition into the Active Safe mode. When in an Active state (i.e. the Active Safe mode or the Active Recovery mode discussed below), the cycle transmitter may periodically send out a message that may be intercepted by an external receiver. An example message may be a UWB message that includes a device ID and a message identifier. As will be discussed in more detail below, such a message may be received at a vehicle receiver of a complementary vehicle safety device in order to warn a driver of a motor vehicle of the presence of the cycle. When in an Idle state (i.e. the Idle Safe mode or the Idle Recovery mode) no messages may be transmitted, or messages may be transmitted with reduced frequency.

The cycle safety device may not be solely used for warning motor vehicle drivers that a cycle is close by, however. The cycle safety device may also be used for tracking the cycle's location, for example, where the cycle is shared between cyclists or where the cycle may have been stolen. The cycle safety device may thus further comprise a location tracker, wherein the location tracker is configured to transmit its location to a computing device and/or a cloud-based server. The location tracker may be a GNSS module, for example, a GPS module.

The cycle safety device may periodically upload information to a cloud-based server and/or physical server, for example via a mobile network or wifi. If the cyclist (or other user, for example the cycle may be rented and the owner of the bike may be a different person/company from the cyclist) has marked their bike as stolen, the cloud-based server and/or physical server may inform the device of this with its response. The cycle may be marked as stolen using an app, for example.

An example server is the “ThingPilot” IoT ecosystem. However, any cloud-based IoT ecosystem could alternatively be used.

A ‘stolen’ response may cause the cycle safety device to move to a Recovery state (i.e. the Idle Recovery mode or Active Recovery mode). During a Recovery state, the cycle safety device may upload data, such as location data, to the cloud-based server more frequently than in the equivalent Safe state, and may also enable Bluetooth Low Energy signals to assist with short range localisation (using a Bluetooth transceiver, if present).

Similarly, when a Safe' message is returned from the cloud-based server and/or physical server, the device may transition back to a Safe state.

If the cycle safety device is in an Active state, and no activity is recognised by the motion sensor for a given amount of time, then the device may return to an Idle state. The amount of time may be, for example, 2 minutes, 3 minutes, 5 minutes, 10 minutes, or longer.

When the cycle safety device uploads data to the cloud-based server and/or physical server, it may also attempt to get its location using the built-in GNSS module (if present), so that a current location may be uploaded.

The cycle safety device may further comprise an application (also termed herein “a cyclist app”) configured to be run on a computing device, wherein the application is configured to cause the computing device to receive a signal from the Bluetooth transmitter of the cycle safety device, wherein the application is configured to present information to the cyclist. The computing device may be a device in possession of a user of a cycle at which the cycle safety device is located, such as a mobile phone, tablet, personal computer, or smartwatch.

The cycle safety device may further comprise a receiver configured to receive a signal from a transmitter located at a motor vehicle (herein also termed “a vehicle transmitter”). The computing device may alternatively or additionally be configured to receive a signal from a transmitter at the motor vehicle.

The computing device may be configured to receive a signal based on that transmitted from the motor vehicle, for example via the Bluetooth transmitter of the cycle safety device.

On receipt of a signal from a vehicle transmitter, the cycle safety device may be operable to provide information to a user of the cycle safety device about the vehicle. The computing device may be configured to display information from the motor vehicle to the cyclist, for example via the cyclist app.

The computing device at the cycle may be configured to run a cyclist app, as discussed above, which may be used to provide the cyclist with information from the GNSS module (if present), for example, their current location on a map. The GNSS module and app may work together to provide route planning to the cyclist.

The cyclist app may allow the owner of the cycle (where the owner is not the cyclist, for example for rented bikes or shared bikes) to track the cycle via the GNSS module, using the cyclist app. This may be useful to a parent, where a child is riding the bike unsupervised, so the parent can track the bike for example.

The cyclist app may deliver ‘last location’ information to a user of the cyclist app, based on information from the GNSS module. This may be particularly useful when the bike is lost or stolen, and the app is used on a remote device (i.e. not also lost or stolen).

The cycle safety device may include an enclosure to house the elements of the device. The enclosure may be formed from a hard-wearing material (metal or plastics material, for example) to protect the elements of the device inside the bike frame; the device may be jostled during riding, for example.

For the location tracker, an antenna of the location tracker may be arranged outside of the bike frame (i.e. external to the seat post and/or seat tube without bike frame material blocking the signal). An example of such an external location tracker could be a location tracker that is present in a cyclist computing device (e.g. mobile phone, cyclist GPS, smart watch). The antenna of the location tracker may alternatively be provided inside the bike frame along with the other elements of the cycle safety device.

The cycle safety device may include an attachment mechanism to hold the cycle safety device in place in the seat post (or elsewhere inside the cycle frame). The enclosure may comprise the attachment mechanism. For example, the cycle safety device may include one or more retractable portions that allow the cycle safety device to fit into the seat post (or elsewhere in the cycle frame) when retracted and hold the cycle safety device in place in the seat post (or elsewhere in the cycle frame) when released from a retracted position. The retractable portions may retract into the enclosure. The retractable portions may be operable to lock into the extended position once in place within a cycle frame in order to resist removal of the device.

The attachment mechanism may otherwise include clips, hooks, adhesive or magnetic portions to attach the cycle safety device in the frame (within the seat post).

A second aspect of the present invention provides a method of installing the cycle safety device described in the first aspect of the invention, the method comprising: removing a saddle and seat post of the cycle from a seat tube of the cycle, such that an inner hollow areas of the seat post and seat tube are exposed; inserting the cycle safety device into the inner hollow area of the seat post or seat tube; and replacing the saddle on the seat tube such that the cycle safety device is held inside the cycle.

As noted above, cycle safety device may be shaped to fit into the seat post and/or seat tube. Installing the cycle safety device may be as simple as placing the enclosure (housing the elements of the safety device) into the seat post or seat tube.

The method may include attaching the cycle safety device to the frame using the attachment mechanism.

A third aspect of the present invention provides a vehicle safety device for fitting to a motor vehicle, for indicating the presence of a cycle to a driver of the motor vehicle, the vehicle safety device comprising: one or more anchors, each anchor comprising at least one receiver, configured to receive a signal from a cycle transmitter located at a cycle (for example within a frame of the cycle), and an alerting system, at least part of which is configured to be positioned adjacent a driver's seat of the motor vehicle, wherein the one or more anchors are configured to communicate with the alerting system and wherein the alerting system is configured to indicate the presence of the cycle to a driver of the motor vehicle based on the communication from the one or more anchors.

The vehicle safety device may comprise a plurality of anchors, each of which comprises at least one receiver. In use, each anchor may be arranged on the motor vehicle, for example on an outer surface of the motor vehicle. For example, the motor vehicle may be an HGV and the anchors may be arranged on a side of a cab of the HGV or elsewhere on the HGV body. The anchors may be arranged adjacent wheels of the motor vehicle, for example.

The or each anchor may comprise an anchor housing, each housing including the at least one receiver. The anchor housing may be configured for attachment to a surface of the motor vehicle. The anchor housing may be configured to attach to an external surface of the motor vehicle, for example. The anchor housing may be formed from a durable material such as metal or plastics material in order to resist wear and tear when attached to an external surface of the vehicle.

Each anchor housing may include one or more fixings operable to attach the anchor (containing one or more receivers) to the motor vehicle. The or each anchor may be simple and cost-effective to retrofit to the motor vehicle. The or each anchor may be permanently attached to the motor vehicle, for example, glued or soldered. Alternatively, the or each anchor may be removably attached, for example, screwed or clipped to the motor vehicle.

It may be desirable to have removable attachments between the or each housing and the motor vehicle, for example, where difference positions of the or each housing on the motor vehicle are contemplated. However, permanent attachment is more effective in preventing theft and/or damage.

The one or more receivers may each be configured to receive ultra-wide band (UWB) signals. The receivers may be transceivers, in that they can both transmit and receive signals, such as UWB signals.

The receiver of each anchor may be configured to receive messages, such as UWB messages, from a cycle safety device of the type discussed above with respect to the first aspect of the invention. Received messages may be timestamped by the receiving anchor with a time of receipt, and then passed on to a processor or local server for processing. The vehicle safety device may include a clock to perform the timestamping of signals, for example a clock at each anchor. The vehicle safety device may include one or more short range vehicle transmitters operable to pass the received UWB messages on to the processor or local server of the alerting system, for example a Bluetooth transceiver may be provided at each anchor, or at a lead anchor which relays messages from the other anchors to the processor.

A PCB module, an example of which is a DWM1001C module, may be provided at the or each anchor, each comprising a UWB transceiver, a BLE transceiver (if required) and a clock.

Two or more anchors may be connected using a wired connection such as ethernet cable. In examples having multiple anchors, the anchors may be configured to be connected to each other in a chain using ethernet cable. The anchors may be supplied power using Power-over-Ethernet (POE). The anchors may be configured to communicate with one another using ethernet cable. For example, a signal may be sent from an anchor to another anchor or from an anchor to the alerting system (for example to the processor or local server) using ethernet cable.

As noted above, the vehicle safety device further comprises an alerting system. The alerting system may comprise the processor and/or the local server. The alerting system may comprise one of the anchors, and in particular may comprise the lead anchor. The lead anchor may receive signals from other anchors and relay those signals to the processor. The lead anchor may transmit synchronisation signals to the other anchors.

The alerting system may define one or more zones, each zone being associated with an area of the vehicle. One or more anchors, and preferably at least two anchors, may be provided in each zone. The processor of the alerting system may use the messages received by the anchors to infer whether a cycle is present in, or is about to enter or exit, one or more of the zones. An alert may be provided to a driver of the vehicle indicating the zone in which a cycle is present, or is about to enter or exit.

As explained above, the motor vehicle may comprise a set of anchors, for example, one or more anchors arranged at or proximate the front of the motor vehicle and one or more anchors arranged at or proximate the back of the motor vehicle. Further anchors may also be provided.

One or more of the receivers of the anchors, and potentially the receivers of each anchor, may each receive a signal indicating the presence of the cycle. The processor or local server may combine the information from the received signals to identify a location of the cycle. Based on the received signals, the processor or local server may be configured to determine a path/route of the cycle past the motor vehicle. The processor or local server may be configured to determine the speed of the cycle passing the vehicle, and the alerting system may be configured to alert the driver to the speed of the cycle by accordingly.

The alerting system may comprise a visual indicator which is configured to be positioned within view of the driver of the vehicle, wherein the visual indicator comprises a lamp configured to indicate the presence of the cycle based on a signal from a cycle transmitter received at one or more of the vehicle receivers. Alternatively or additionally the visual indicator may comprise a screen configured to depict the location of the cycle with respect to the vehicle based on a signal from the transmitter received at one or more of the receivers, and/or configured to indicate the location of the cycle using words or pictures on the screen based on a signal from the transmitter received at one or more of the receivers.

The visual indicator may be arranged in the motor vehicle in view of the driver (for example, in front of the driver's seat, between the driver's seat and a windscreen of the motor vehicle).

The visual indicator may be configured to display other information relating to the motor vehicle's journey-for example-or general information (for example the time, the weather and the like). The alerting system may comprise a GNSS tracking system, for example a GPS tracking system, and the visual indicator may display a map or other location service (such as directions/a route) based on the GPS tracker.

The visual indicator may comprise a touchscreen, physical buttons or other interactive elements allowing the driver to control the visual indicator or alerting system. For example, the driver may be provided with the option to view a feed from a camera arranged on the motor vehicle (see below), or to view still images captured by the camera. The driver may be provided with the option to view past alerts that a cycle is within range of the motor vehicle. The driver may be provided with the option to put the visual indicator into a sleep mode (i.e. not displaying anything) until there is an alert that a cycle is within range, which needs to be displayed. In this way, distractions due to the visual indicator may be minimised.

The alerting system may be configured to put the visual indicator into such a sleep mode automatically when there is no cycle within range to be indicated to the driver. This may save power. Likewise, the alerting system may be configured to bring the visual indicator out of sleep mode in order to make an alert to the driver.

The alerting system may comprise a speaker configured to indicate the location of the cycle using sound, based on a signal from the transmitter. For example, a bell sound, horn sound or other alert sound may be used to alert the driver to a cycle being in range. A human voice recording may be used to alert the driver.

The vehicle safety device may comprise one or more power sources. For example, the vehicle safety device may include one or more batteries (for instance, each anchor may include a battery). Additionally or alternatively, the vehicle safety device may be integrated into the motor vehicle's power. The vehicle safety device may be configured to be connected to the motor vehicle's power source when the one or more anchors are installed, for example.

In one example, the vehicle safety device may be configured to be connected to a power source that powers the motor vehicle's lights. An example method of connecting the safety device to power includes splicing a cable of the vehicle safety device with wiring of the motor vehicle lighting. This may be done in the same or similar way to the manner in which a powered trailer may be connected to a motor vehicle. Some motor vehicles already include a cable for trailers and the same cable may be used to power the safety device, making retro-fitting of the safety device to such a motor vehicle simple.

In a case where the vehicle safety device is wired in with a lighting circuit of the motor vehicle, the vehicle safety device may be configured to sense when light such as a turn signal light and/or reversing light is used and the alerting system may be configured to base an alert to the driver on use of the light.

The alerting system may be configured to process a turning signal and/or reversing signal and may display information based on the turning signal and/or reversing signal to the driver, for example a warning that a cyclist is present in the direction that the driver has used the turn signals or that a cyclist is behind the reversing vehicle.

Accidents sometimes happen at traffic lights, for example, where a cyclist has not been spotted by a turning driver. There is a window of time to indicate to the driver that a cyclist is present at traffic lights because the driver will be stationary for a time and waiting to turn, with the turn signal activated. By wiring the vehicle safety device in with turn signals (i.e. left and right indicators) of the vehicle, there is extra information for the safety device to consider. If the driver indicates a left turn and a cyclist is sensed on the left side of the motor vehicle, the alerting system may indicate to the driver that a cyclist is present within their turning arc, for example.

Additionally or alternatively, the vehicle safety device may be configured to communicate with the cycle safety device based on use of the turning signal lights and/or reversing lights. For example, a transmitter of the vehicle safety device may transmit a signal indicating the direction of turning (based on the turning light used) or a signal indicating that the vehicle is reversing to a receiver of the cycle safety device, which may alert the cyclist (e.g. via the cyclist app). This may allow the cyclist to change path to avoid a collision. The transmitter may be a UWB transceiver of the type discussed herein (for example a transceiver of the lead anchor) or may be an additional transmitter included within the vehicle safety device, such as a cellular transmitter.

The vehicle safety device may further comprise a computing device as part of the alerting system-for example, a remote computing device such as a smartphone, tablet or laptop. In one example, a tablet with a driver app may connect to an anchor, such as the lead anchor, via BLE, and then may display the status of a vehicle's indicators, as well as highlighting a zone in which a cycle has been detected. If a cycle is detected while the vehicle is indicating, then an audible notification may also be provided. The computing device may then upload information about any interactions with a cycle to the cloud-based server (for example, ThingPilot).

The computing device may provide a speaker for audible alerts to the driver of the motor vehicle. The computing device may also/otherwise provide the screen for provision of visual indicators to the driver. The computing device may provide the touchscreen, for the driver to select what to view on the screen from the alerting system.

The vehicle safety device may further comprise a camera configured to provide image information to the alerting system and/or to a cloud-based server and/or a physical server, wherein the alerting system is configured to indicate the presence of a cycle based on an image captured by the camera.

The image information may comprise video and the alerting system may display the video in real time (i.e. live feed) on a screen or may display the image information at a later stage. The image information may comprise video or still images and the alerting system may display stills taken from the video or the still images to the driver on a screen.

The camera may have a framerate of around 17 fps. The applicant envisions improving the framerate as more research and testing is performed.

Multiple cameras may be used to provide additional image information. Multiple cameras may be positioned together and/or cameras may be arranged on the motor vehicle in different positions to capture different images.

The computer vision system (mentioned above) may include an image processing module configured to process images from the camera. The vehicle safety device may include the computer vision system (which may also comprise the camera).

The computer vision system may further comprise a computational unit configured to identify a cycle in an image captured by the camera. This may offer an additional level of protection for cycles with cycle safety devices that the one or more receivers will receive a signal from and therefore that the alerting system will alert the driver to, or the computational unit performing image processing may allow cycles not including the cycle safety device to be identified. The alerting system may be configured to alert the driver to the presence of a cycle in an image captured by the camera, and/or to identify to the driver the zone in which a cycle has been identified.

The camera may be arranged at or adjacent the front of the motor vehicle. The camera may be configured to capture an image of the road ahead of the motor vehicle. The camera may be configured to capture an image with a field of view including the peripheral vision of the driver (based on the field of view of the driver sitting in the driver's seat). The camera may capture an image including some image detail of the left-hand and right-hand sides of the motor vehicle. In this way, the camera may capture a cycle that is sitting outside of the driver's field of view, ahead of the motor vehicle but blocked from view (for example, where the motor vehicle has a raised cab and blind spots close to the front of the vehicle as a result).

The camera may be configured to record video footage and/or sound and to store the footage at a storage medium of the safety device, at the local server, or at the cloud-based server or physical server remote from the motor vehicle. This may be useful for vehicle insurance, as evidence of good driving (or poor driving), or the like.

The camera may be arranged at or adjacent the back of the motor vehicle to capture a view of behind the vehicle. This may be useful to identify cycles approaching from the rear, that the driver may not have seen in their rear-view mirror or wing mirrors, for example. Cycles may overtake the motor vehicle due to their comparatively small size-being able to weave into smaller spaces-and the camera at the back of the motor vehicle may capture a cycle approaching and about to overtake, which the computational unit may identify and alert the driver accordingly.

Further details of the operation of the anchors and alerting system are discussed below in connection with a fourth aspect of the invention. It will be appreciated that the features of all four aspects of the invention may be combined with each other, and with features set out in the description.

A fourth aspect of the present invention provides a cycle safety system comprising:
a cycle safety device for attachment to a cycle, the cycle safety device comprising a cycle transmitter; and
a vehicle safety device comprising one or more anchors, each including at least one vehicle receiver, and an alerting system, at least part of the alerting system configured to be positioned adjacent a driver's seat of a motor vehicle,
wherein the cycle transmitter is configured to transmit a signal advertising the presence of the cycle transmitter,
wherein the one or more vehicle receivers are configured to receive the signal advertising the presence of a cycle transmitter, and to communicate with the alerting system, and
wherein the alerting system is configured to indicate the presence of a cycle to a driver of the motor vehicle including the vehicle safety system based on the communication from the one or more vehicle receivers.

The cycle safety device may be mounted to the cycle, external to the cycle. Alternatively, the cycle safety device (or part thereof) may be shaped for insertion into the cycle frame (the body of the cycle). For example, the cycle safety device (or part thereof) may be installed in a seat post or seat tube of the cycle. The seat post is a part extending from a saddle, for insertion into the seat tube of the cycle frame, to hold the saddle in place and allow the height of the saddle to be adjusted. Seat posts and seat tubes are (typically) hollow-the cycle safety device may therefore be configured to be inserted into the seat tube or seat post. The cycle safety device may be shaped to be inserted into the seat tube or seat post. For example, the cycle safety device may have a generally circular cross-section.

The cycle safety device may be of the type described above in connection with the first aspect of the invention.

The cycle safety device may be configured to be externally mounted to the cycle, for example by attaching to the frame, or utilising a fitting position associated with cycle air pumps or water bottles (once fixed to the frame in the position of pump or bottle, the cycle safety device may offer an intermediary mounting facility for these accessories). The cycle safety device may thus have a shape suitable for attachment to a fitting position associated with cycle air pumps or water bottles.

In a situation where a cyclist (i.e. a rider of the cycle) may be in danger of colliding with a motor vehicle on the road, the cycle safety system may alert the driver of the motor vehicle to the presence of the cycle (and therefore the cyclist), offering improved safety. The cycle may be a bicycle, scooter, motorcycle, or the like. The cycle may be powered (for example, electric or fuel) or may be a push/pedal bike.

The vehicle safety device may be of the type described above with respect to the second aspect of the invention.

The cycle safety system, and in particular the vehicle safety device, may be used to alert a driver of the motor vehicle when a cycle (and therefore a cyclist) is within a predetermined range of the motor vehicle, for example within 1, 2, 3, 4, 5, 10 or more metres of the vehicle.

At least part of the alerting system may be arranged adjacent the driver's seat of the motor vehicle in use, or configured to be so arranged, such that the part is close enough for the driver to see and/or hear an alert from the system. The at least part of the alerting system may be arranged inside the cab of an HGV, for example. The at least part of the alerting system may be arranged on a dashboard of the motor vehicle, on the driver's seat itself, or on the roof of the motor vehicle (above or to a side of/in front of/behind the driver's seat).

The cycle safety system may define one or more zones within a vehicle boundary region. Each zone may be an area defined relative to a region of the motor vehicle. Alternatively, or additionally, each zone may be an area defined relative to an anchor, or to a plurality of anchors, such as a pair of anchors. A front zone may be defined adjacent the front of the vehicle and may include one or more front anchors. A rear zone may be defined adjacent a rear of the vehicle and may include one or more rear anchors. A left turning zone may be defined adjacent a front left of the vehicle, and may include one or more left anchors. A right turning zone may be defined adjacent a front right of the vehicle, and may include one or more right anchors. Some anchors may be included in more than one zone (for example a front left anchor may be present in both the front zone and the left zone), such that some of the zones may overlap. The vehicle receivers may each be configured to receive a signal transmitted by a cycle transmitter that is present in the vehicle boundary region. The alerting system may provide an alert to the driver which indicates the particular zone or zones that the cycle is about to enter, is stopped in, is passing through, or has exited.

Multiple anchors, each including a vehicle receiver, may be arranged along the length of the motor vehicle. The vehicle may be an HGV or another comparatively long vehicle, such that the anchors may be located one or more metres apart (e.g. 1. 1.5, 2, 2.5, 3, 4, 5 metres apart, or more).

The vehicle receivers may each be configured to receive a signal transmitted by a cycle transmitter that is not present in the vehicle boundary region, but which is approaching the vehicle boundary region. The alerting system may provide an alert to the driver which indicates that the cycle is approaching the vehicle.

The anchors of the vehicle safety device may be arranged in pairs, for example, a first pair of anchors (which together comprise a first pair of vehicle receivers), a second pair of anchors (which together comprise a second pair of vehicle receivers), a third pair of anchors, and so on. The alerting system may be configured to estimate the position of the transmitter by measuring the difference in the time of arrival of a signal received from a cycle transmitter at each of the receivers of an anchor pair. One or more anchors may serve in more than one anchor pair.

One or more of the anchors at the motor vehicle may further comprise a short range transmitter configured to send short range signals, such as Bluetooth low energy (BLE) signals. The alerting system may comprise a BLE signal receiver/transceiver to communicate with the one or more anchors via BLE. In this way, information to be provided to the driver of the motor vehicle at the alerting system may be transmitted via BLE on board the motor vehicle.

A cycle transmitter may have a range of 10 metres or more, for example 20, 30, 50, 100, 500 metres or more. Thus at least two vehicle receivers may be able to receive a signal transmitted from the cycle transmitter at the same or similar times. Further, one or more vehicle receivers may be operable to receive a signal transmitted from the cycle transmitter before a cycle enters the vehicle boundary region.

The cycle transmitter may be configured to transmit a signal at a radio or microwave frequency. The cycle transmitter may be configured for short-range radio transmission.

The cycle safety system may use ultra wide band (UWB) technology. The cycle transmitter may be an ultra wide band transmitter, and may be an UWB transceiver (i.e. operable to both transmit and receive). The one or more vehicle receivers may be configured to receive an ultra wide band signal, and may also be UWB transceivers.

UWB transmits data in a way that spreads radio energy over a wide frequency band with a low power spectral density. The wide bandwidth may exceed 500 MHZ, and may exceed 1000 MHz, or 2000 MHz. For example, each transceiver may comprise a UWB chip configured to transmit within a frequency range of 3.5 GHz to 6.5 GHz (inclusive).

UWB may be used to determine the time of flight (ToF) of a transmission from the transmitter at the cycle. The one or more receivers at the motor vehicle may receive the UWB signal from the transmitter at the cycle. The alerting system may comprise a processor and/or a local server, which may receive signal information from the one or more receivers and may determine, based on the UWB signal, the location of the cycle with respect to the motor vehicle (by determining the distance between the transmitter and the one or more receivers). As such, providing a set of receivers, each of which may receive a signal from the transmitter at the cycle, may allow the processor/local server to pinpoint the cycle's location better than providing just one receiver.

UWB may be used to determine the time difference of arrival (TDoA) of a signal to two different vehicle receivers (e.g. at the two receivers of an anchor pair). This is an alternative approach to determining the time of flight. In TDoA, the difference in time that a signal is received by any given pair of receivers is measured. For example, if a first receiver ‘A’ receives a signal at time x nanoseconds later than a second receiver ‘B’ receives the signal, the difference in distance from the receivers to a transmitter (such as the cycle transmitter) can be determined based on x. The actual distance between A and the transmitter or B and the transmitter is not determined. Instead, a hyperbolic curve can be calculated that represents possible locations of the transmitter (at the cycle) to have given the measured TDoA. By measuring the TDoA with multiple receiver pairs and identifying intersections of the resulting hyperbolas, the possible locations of the transmitter can be reduced and the location of the cycle with respect to the vehicle can be estimated.

Using the TDoA approach may require less power than ToF and therefore allow for a longer battery life for the transmitter.

For positioning applications, Bluetooth based solutions (for example) rely on monitoring changes in signal strength to determine distances. The approach described here, using UWB, relies on transmission of an identifier (ID) and timestamp over ultra wide band radio.

UWB may be preferable to other solutions (e.g. laser or camera tracking) where it is desirable for a signal to penetrate an object. UWB may work well through a metal cycle frame, without a reduction in performance versus the open air. Loss is minimised even where there are obstructions, as UWB does not rely on signal strength.

In one example, a receiver closer to the back of the motor vehicle may receive a signal from a cycle. A receiver at the front of the motor vehicle may not. This may indicate that the cycle has stopped moving and is near to the rear of the vehicle. The processor or local server may determine from the presence of a signal at the back of the motor vehicle and a lack of a follow-up signal at the front of the motor vehicle that the cycle has stopped near the back of the vehicle or is moving particularly slowly from the back of the vehicle towards the front, and the driver may be alerted by the alerting system accordingly.

This may be particularly relevant in the case of traffic lights, where the motor vehicle is looking to turn left or right. Identifying a cycle that has stopped on the inside' of the motor vehicle (i.e. between the motor vehicle and the direction it is turning) and alerting the driver may prevent the common road traffic accident type in which a larger vehicle turns a corner without the driver spotting a cyclist, who proceeds forwards (without turning) and ends up in a collision with the motor vehicle.

One or more of the anchors may be arranged on an edge or a corner of the motor vehicle, for example. This may minimise signals being blocked by the motor vehicle.

In one example, where a receiver fails to pick up a signal from the transmitter, TDoA can still be applied using the receivers that have received the signal. Using data from fewer receivers may decrease the accuracy but a position of the cycle can still be estimated. As the cycle passes the vehicle, the contribution from receivers at anchors that are further from the cycle may provide less of a contribution to the accuracy of localisation in any event, so if a receiver falls out of range there is little effect on the estimation.

The motor vehicle may extend a length behind a driver's seat and the motor vehicle may comprise one or more receivers at or proximate the centre of the length. This or these additional receivers may offer the same benefits as having a front and a back receiver, as above. Longer vehicles (for example HGVs) may benefit from having receivers spaced along their lengths, which may be evenly spaced along the length of the vehicle.

The motor vehicle may comprise one or more receivers on a left side of the motor vehicle and one or more receivers on the right side of the motor vehicle. In this way, whether a cycle passes the vehicle on the left or the right, at least one receiver can receive a signal from the cycle. The left and right sides may be distinct from the front and back of the motor vehicle. For example, the left and right sides may be defined from the perspective of a driver sitting in the driver's seat and looking forwards at a road. The left side may comprise a door and the right side may comprise a door, for example, or each side may comprise a wing mirror.

The motor vehicle may include a plurality of receivers on only one side (left or right-the directions being judged as if by the driver sat in the driver's seat) depending on the side that a cycle is most likely to pull alongside (which may differ based on road laws in different countries). However, having receivers on each side improves the overall safety benefits of the cycle safety system.

The UWB signal transmitted by a cycle transmitter may include an ID of the cycle safety device. The ID may be a number or string of numbers and/or letters, for example. The ID may be assigned to the particular cycle transmitter at manufacture or may be established at the time of first use of the cycle transmitter with the cycle, for example. The cyclist (or another user) may create the ID at first use or at another time. This allows the cycle transmitter that is the source of the signal (conveying the message) to be identified (since more than one cycle may include a cycle transmitter).

The UWB signal may include a message identifier. The message identifier allows each vehicle receiver to register the time of receipt of the message from the cycle transmitter. The message identifier may be numerical and may indicate the order in which the message was sent as part of a sequence, for example using increasing incremental digits.

For example, a message may contain the following: BikeId: 123, MsgId: 001, or BikeId: 123, MsgId: 002, or BikeId: 123, MsgId: 003, for example. Each of these identifies the same cycle transmitter as its source but each uses a different message identifier in order to indicate that each message is a different instance of transmission.

If two vehicle receivers both receive the same message (e.g. BikeId: 123, MsgId: 002), the specific message from the same transmitter can be identified and the timestamps of the messages can be correlated to determine time difference of arrival.

Typically, transmitters/receivers should have a clear line of sight (LOS) between their antennae for the best range and accuracy of positioning. However, UWB allows for non-line-of-sight (NLOS) communication between transmitters and receivers through a metal, such as a cycle frame.

The cycle safety device and/or the vehicle safety device may be configured to communicate with a cloud-based server, and the alerting system may be configured to provide information to the driver of the vehicle based on information from the cloud-based server.

In order to communicate with the cloud-based server, the cycle safety device and the vehicle safety device may each be configured to connect to the Internet. Communication with the cloud-based server may be via WiFi, for example connecting to WiFi hotspots, or by mobile data such as 3G, 4G or 5G, nb-IoT or LTE-M. The cycle safety device and/or vehicle safety device thus may comprise an appropriate cellular transmitter. Alternatively, data may be relayed to a computing device via the cyclist/driver app, which may utilise a cellular transmitter present in the computing device.

The vehicle safety device may be configured to transmit a signal to the cloud-based server, for example a signal comprising the information being displayed to the driver of the motor vehicle.

As such, the cloud-based server may be used to store information about cycles being within detection distance of the motor vehicle and/or information about what has been shown or otherwise indicated to the driver, for example.

The vehicle safety device may include or may be in signal communication with one or more driver monitoring elements and data recorded by the driver monitoring elements may also be communicated to the cloud-based server by the vehicle safety device. Example driver monitoring elements may be: a speedometer, a camera, a microphone, a motion sensor, a braking sensor, and the like.

The vehicle safety device may be configured to monitor the time between an alert of the location of a cyclist who is close to the motor vehicle and the driver's braking time (i.e. reaction time), for example.

The cloud-based server may therefore store information that may be useful in driver monitoring. This may be of particular interest to a fleet manager, for example-the content delivered to the cloud-based server may be accessible by a fleet manager or other authorised person. Driver monitoring in this way may also be a useful training tool, driver testing tool or a useful way to help a driver rehabilitate after a road traffic accident.

The cycle safety device may comprise one or more short range transmitters. For example, a Bluetooth transmitter may be provided in addition to the longer range cycle transmitter discussed above, and may be configured to use Bluetooth Low Energy (BLE) to transmit a signal a short range. BLE may not be used to alert a driver of a motor vehicle (via the vehicle safety device) that the cycle is approaching or passing (instead UWB may be used, as discussed above, for better accuracy, range, and to avoid loss of quality due to obstructions) but may form part of the safety system, providing a different function. The Bluetooth transmitter may use BLE to transmit a signal to a computing device located at the cycle, for example the cyclist's smartphone (which may be mounted on the bike) or the cyclist's smartwatch. The

Bluetooth transmitter may use BLE to transmit a signal to Bluetooth headphones worn by the cyclist, for example, to provide an audible alert.

As discussed above in connection with the first aspect of the invention, the cycle safety system may comprise a mobile application (cyclist app) for the cyclist to use, for example to monitor their bike. The cyclist app may be run on a computing device accessible to the cyclist, for example a smartphone or smartwatch, as above. The computing device may comprise one or more computing device receivers configured to receive a signal from the cycle safety device (such as a short range, e.g. BLE, signal) and/or a signal from the vehicle safety device (e.g. via BLE, cellular or other mechanism). The cyclist app may be configured to display information, such as safety warnings, to the cyclist based on the signals received. The app may have other useful features not necessarily tied to cyclists' safety, such as route suggestions or traffic information.

The cycle safety device may be operable to receive information from the cloud-based server and/or from a vehicle comprising a vehicle safety system, for example via the UWB cycle transceiver. The cycle safety device may comprise an indicator to indicate information from the cloud-based server to the cyclist—for example, a screen or speaker. Therefore, it may be that only part of the cycle safety device is arranged inside the bike frame—a screen or speaker may be arranged (at least partially) external to the bike frame in order to make an alert to the cyclist effectively. However, having a physical indicator at the cycle at all times may make the cycle safety device less compact, which may not be desirable. Instead, the cloud-based server may be configured to communicate with a computing device on which the cyclist app is installed to provide information to the cyclist-for example, the cyclist's smartphone or smartwatch, headphones (via a mobile device), GPS or cycle computer.

The cloud-based server may be configured to communicate with a physical server that is remote from the motor vehicle or the cycle. The physical server may be configured to store information from the cloud-based server.

The device running the cyclist app (e.g. the smartphone or smartwatch) may also be configured to communicate with the cloud-based server and/or physical server. Information from either server may be supplied to the cyclist via the app.

Another aspect of the invention provides a cycle comprising the cycle safety device described above in connection with the first, second and fourth aspects of the invention.

Another aspect of the invention provides a motor vehicle comprising the vehicle safety device described above in connection with the third and fourth aspects of the invention. The motor vehicle may be a heavy goods vehicle.

### BRIEF DESCRIPTION OF THE DRAWINGS

Embodiments are described in more detail below with reference to the accompanying figures, in which:

FIG. 1 shows a cycle, a motor vehicle, and a cycle safety system;

FIG. 2 schematically shows a cycle including a cycle safety device;

FIG. 3 shows a cycle safety device and a remote computing device;

FIG. 4 shows a schematic top view of a motor vehicle including a vehicle safety device;

Figure da shows a further schematic top view of a motor vehicle including a vehicle safety device;

FIG. 5 is a schematic drawing of a tracking system for the cycle;

FIG. 6 shows further detail of an example cycle safety system;

FIG. 7 shows a motor vehicle and example camera positions; and

FIG. 8 shows steps of a method of installing a cycle safety device.

### DETAILED DESCRIPTION

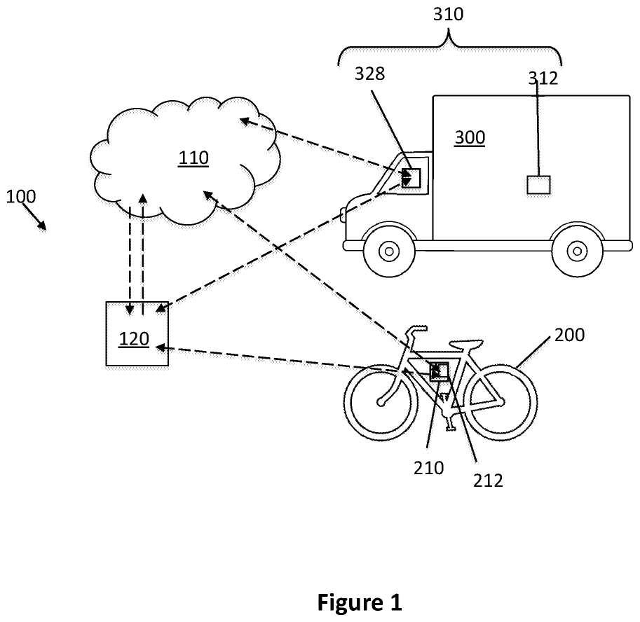

FIG. 1 shows a cycle safety system 100. Parts of the system 100 are arranged at a cycle 200 (shown as a pedal bike in this example), parts of the system 100 are arranged at a motor vehicle 300 (shown as a lorry in this example) and parts of the system 100 are remote from each of the cycle 200 and motor vehicle 300. The cycle 200 and vehicle 300 are not shown to scale.

The cycle safety system 100 comprises a cycle safety device 210 (for the cycle 200) and a vehicle safety device 310 (for the vehicle 300). The cycle safety device 210 includes at least one cycle transmitter 212. The vehicle safety device 310 comprises at least one vehicle receiver 312 and an alerting system 328. The vehicle receiver(s) 312 are configured to receive messages transmitted by the cycle transmitter 212. Both the cycle transmitter 212 and the vehicle receivers 312 are in this case transceivers, and in particular ultra-wide bane (UWB) transceivers, so as to be capable of two way communication.

FIG. 1 further illustrates a cloud-based server 110 and a physical server 120. The cycle safety system 210 and the vehicle safety system 310 may communicate with the cloud based server 110 and/or the physical server, which may also communicate with one another. The communication between servers 110, 120 cycle safety system 210 and vehicle safety system 310 may be via a different mechanism (e.g. a mobile network) to the communication between the cycle transmitter 212 and vehicle receivers 312, or may be via the same mechanism (e.g. UWB).

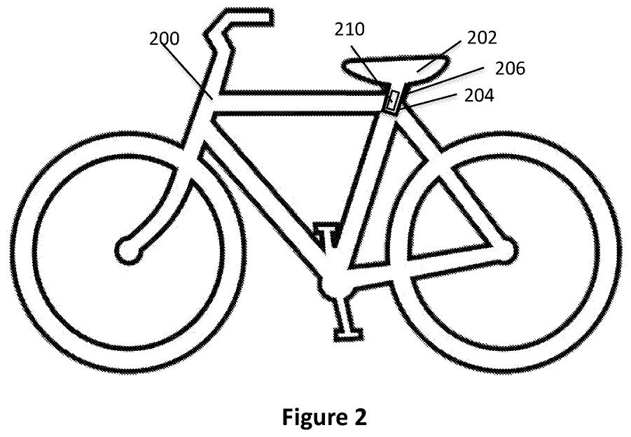

FIG. 2 shows a schematic cross-sectional view of the cycle 200 including a saddle 202, a seat post 204 and a seat tube 206. The cycle safety device 210 is shown attached to the cycle 200 within the seat post 204 in this example.

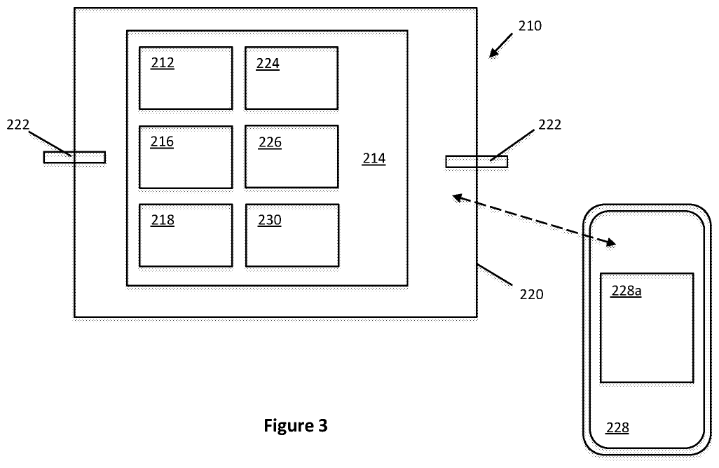

FIG. 3 shows the cycle safety device 210 in more detail. The cycle transmitter 212 and other elements are shown in an enclosure 220. The enclosure 220 is shown including a pair of retractable portions 222, one on either side of the enclosure 220, for holding (e.g. securing) the cycle safety device 210 in the frame of the cycle 200, for example in the seat post 204 or seat tube 206. Any suitable number of retractable portions 222 may be included (which may be one), or another attachment mechanism may be used, such as one or more clips or hooks, an adhesive, or one or more magnetic portions.

The cycle safety device 210 may comprise a printed circuit board (PCB) 214, electrically connecting elements of the device 210. The cycle safety device 210 may comprise, in addition to the cycle transceiver 212, a global navigation satellite system (GNSS) module (or ‘location tracker’) 216 and/or a second transceiver 218 and/or a motion sensor 224. The cycle safety device 210 may comprise a processor 230 configured to process a signal received at the cycle transceiver and/or the second transceiver 218, for example, or to process information (e.g. received information or sensed information) for sending as a transmission from the cycle transceiver 212 and/or the second transceiver.

The cycle safety device 210 may include a power source 226 for the powered elements of the device 210, such as a battery.

The cycle safety system 100 may comprise a mobile application (app) for installation on a user's computing device, in order to display information to a cyclist on the cycle 200. FIG. 3 shows an example computing device 228 in communication with the cycle safety device 210, on which an app 228a is installed. The transceiver 218 is, in this example shown, a short range Bluetooth low energy transceiver that is operable to pair with the computing device in order to permit data transmission between the transceiver 218 and the computing device 228.

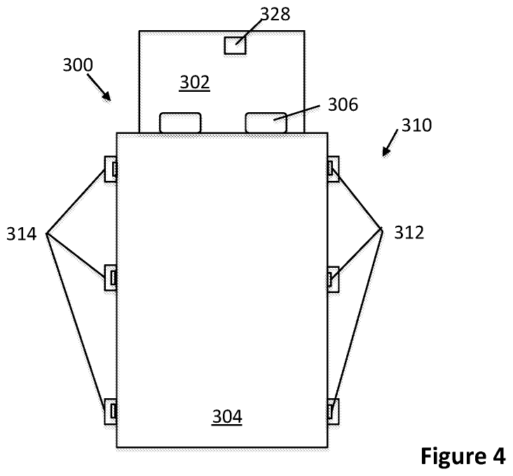

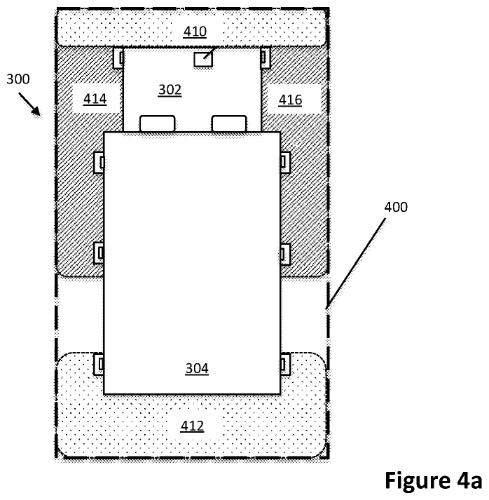

FIG. 4 shows the motor vehicle 300 including a vehicle safety device 310. The vehicle safety device 310 comprises a plurality of anchors 314, each including a vehicle receiver 312. The size of the anchors 314 and the receivers 312 shown in FIG. 4 is not to scale with respect to the size of the vehicle 300. Here, the vehicle 300 is an HGV 300 with a cab 302 and a load 304 rear of the cab 302.

Six anchors 314 are shown in FIG. 4, but any number of anchors 314 may be used, for example one, two, three, four, five, seven, eight or more anchors 314, each including a respective receiver 312. Having receivers 312 on each of the left-and right-hand sides of the vehicle 300, as shown, improves safety as signals from a cycle transmitter 212 may be received from either of the sides. Receivers 312 may be arranged on the front-or back-sides of the motor vehicle 300, additionally or alternatively.

FIG. 4 shows seats 306 in the cab 302. In the figure, a driver's seat 306 is shown on the right-hand side, according to UK driving conventions. Of course, the driver's seat 306 may be located on the left side to drive in countries with different road traffic laws.

FIG. 4 shows an alerting system 328. The alerting system 328 may comprise a visual indicator, such as a screen, and the visual indicator may be arranged closer to a windscreen of the vehicle 300 than the driver's seat 306 so that the driver can receive visual information while driving the vehicle 300 (and looking forwards at the road). The alerting system 328 may comprise a speaker and may be configured to use sound to indicate the presence of a cycle 200 to the driver. In this example, there is no need for the speaker to be arranged in view of the driver (i.e. in front of the driver's seat) as for a visual indicator. The speaker may be located anywhere suitable within the cab 302, for example, on the roof of the cab 302 or in the driver's seat 306 itself or elsewhere within earshot of the driver. The speaker may be included in headphones., for example. The alerting system may therefore be configured to send a signal to the headphones for the driver to receive an audible alert.

The alerting system 328 may comprise a smartphone, tablet, smartwatch or other computing device in order to convey an alert of the presence of a cycle 200 to the driver of the motor vehicle 300. The computing device may comprise both a screen and a speaker, such that either or both visual and audible alerts can be used, for example. The computing device may connect to headphones, for example, to convey an audible alert to the driver.

FIG. 4a shows a similar vehicle to that of FIG. 4, but in this instance the vehicle is fitted with a vehicle safety system that includes eight anchors. As well as anchors at the same locations as shown in FIG. 4, two additional anchors are located on the front corners of the vehicle cab.

A vehicle boundary 400 is shown, which is a notional boundary defining “a vehicle boundary region”. The vehicle boundary region is a region of space around the vehicle within which a driver of the motor vehicle should be cautious of interactions with other vehicles, and in particular with cycles. The alerting system 328 is configured to alert a driver in the event that the processor determines, using information received by the anchors, that a cycle transmitter is present within the vehicle boundary. In some instances the alerting system may be configured to alert the driver that a cycle transmitter is approaching the vehicle boundary. For example, a transmitter may be detected to be behind, in front or to one side of the vehicle, and moving in a direction and/or at a speed that indicates the cycle is likely to enter the vehicle boundary region.

The alerting system can thus be configured to alert a driver when a cycle transmitter is detected to be within a predefined distance of the vehicle. The distance may differ depending on the direction of the cycle with respect to the vehicle. For instance, the distance may be 3-5 metres from a front or rear of the vehicle, and 1-2 metres from a left or right of the vehicle. It will be appreciated that the extent of the vehicle boundary region may be vehicle-or indeed driver-specific, and may be configurable at the alerting system.

The vehicle boundary region in FIG. 4a is shown divided into zones. In particular, the region includes a front zone 410, a rear zone 412, a left zone 414 and a right zone 416. The alerting system 328 of FIG. 4a is operable to indicate to the driver which zone a cyclist is determined to be in. The left and right zones may overlap the front and rear zones as shown, such that a cycle located in an overlap region could be reported to be in both zones, or could be reported as present in an overlap zone (being the intersection between the overlapping zone).

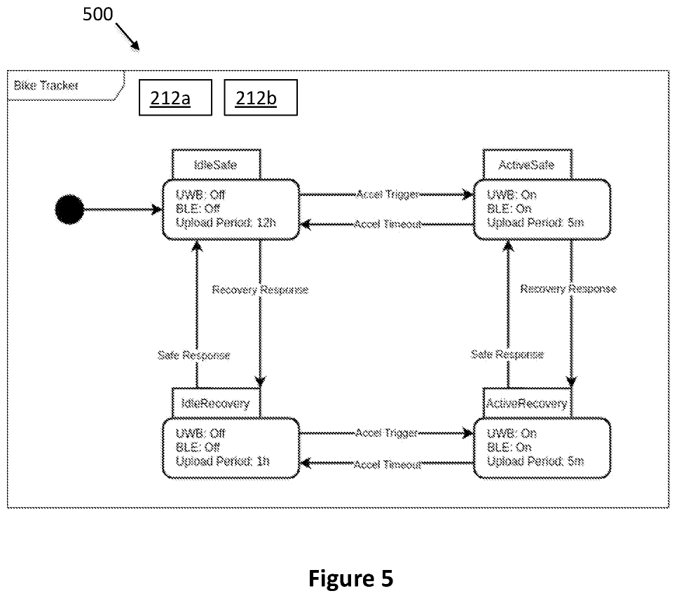

FIG. 5 shows a tracking system 500 for the cycle 200. The cycle safety device 210 comprises a location tracker 216, such that the cycle safety device 200 may be used to track the cycle if it is stolen or lost. The example operating states of the cycle safety device 200-Idle Safe, Active Safe, Idle Recovery and Active Recovery-are represented in FIG. 5 with the respective statuses of a UWB transmitter 212a and a BLE transmitter 212b.

Idle Safe represents the status of the cycle when not in use, and when not reported stolen or lost. The UWB transmitter 212a and BLE transmitter 212b are not in use-shown as OFF. The cycle safety device 210 may be configured to upload information to the cloud-based server 110 and/or physical server 120 every twelve hours, for example, or another time which is less frequent than when the cycle 200 is in use. Upload may be made by the UWB transceiver 212a. This may save power and storage space, for example.

In FIG. 5, the motion sensor 224 comprises an accelerometer ('Accel'). The accelerometer is triggered when the cycle 200 is moving, indicating that a cyclist is riding the cycle 200 or the cycle 200 has otherwise been moved. This places the cycle safety device 210 in an Active Safe mode on the assumption that the cyclist is the one moving the cycle 200, i.e. that it has not been stolen. The UWB transmitter 212a is ON and the cycle safety device 210 transmits to the cloud-based server 110 and/or physical server 120 every five minutes. The period may be longer or shorter, for example, every ten minutes or every two minutes, but five minutes is the depicted example. The period may be shorter for the Active Safe mode than the Idle Safe mode, accordingly.

If the accelerometer stops detecting motion, then the Active Safe mode may time out as shown in FIG. 5. There may be a predetermined period after the accelerometer stops detecting motion of the cycle 200 before time out, or the Idle Safe mode may be entered automatically when the cycle 200 stops moving. A predetermined time period may cover stoppages during a journey, such as traffic lights, for example, so may be around one or two minutes for example. This may prevent the Idle Safe mode being entered while the cycle 200 is actually still in use.

If the cycle 200 is in the Idle Safe mode and the owner indicates that the cycle 200 is lost or may have been stolen, by way of the app, then the cycle safety device 210 may enter the Idle Recovery mode. This may be referred to as a Recovery Response, according to FIG. 5. In this mode, the cycle 200 is not moving (for example, has been left chained to a post and the owner has forgotten the location). The UWB transmitter 212a and the BLE transmitter 212b may both be OFF in this mode. The cycle safety device 210 may upload to the cloud-based server 110 and/or physical server 120 every one hour, for example. The cycle safety device 210 may upload to the cloud-based server 110 and/or physical server 120 more frequently than in the Idle Safe mode, but maybe less frequently than in the Active Safe mode (where the cycle 200 is moving so updates are needed more frequently).

The owner/other user of the cycle 200 may indicate via the app that the cycle 200 is safe (has been found). This may lead to a Safe Response according to FIG. 5, in which the cycle safety device 210 resets to the Idle Safe mode.

FIG. 5 also shows the Active Recovery mode. This mode may be entered from the Idle Recovery mode or from the Active Safe mode, as shown.

Similar to the Idle Recovery mode, the Active Recovery mode may be entered if the owner/other user logs in the app that the cycle 200 has been stolen or is lost-but where the cycle 200 is on the move.

As shown in FIG. 5, if the cycle safety device 210 is in the Idle Recovery mode and then the accelerometer senses that the cycle 200 starts to move, the cycle safety device 210 may enter Active Recovery mode. In that mode, the UWB transmitter 212a and the BLE transmitter 212b are ON and the upload period is five minutes. This is one example and the upload period may be shorter (for example, every two minutes) or longer (for example, every ten minutes); however, more frequent uploads may help the cycle 200 to be found more quickly.

As shown, if the accelerometer times out, i.e. stops detecting motion, then the Idle Recovery mode is entered. The cycle 200 is still lost but is now stationary. As above, there may be a predetermined time for which the cycle 200 must be stationary before the accelerometer times out and the mode is changed.

If the owner/other user identifies the cycle 200 as safe, then the cycle safety device 210 may perform a Safe Response and enter Active Safe mode. If the cycle 200 is also now stationary, Idle Safe mode may be entered, as indicated by the arrows in FIG. 5. As above, identifying the cycle 200 as safe may be done via the app.

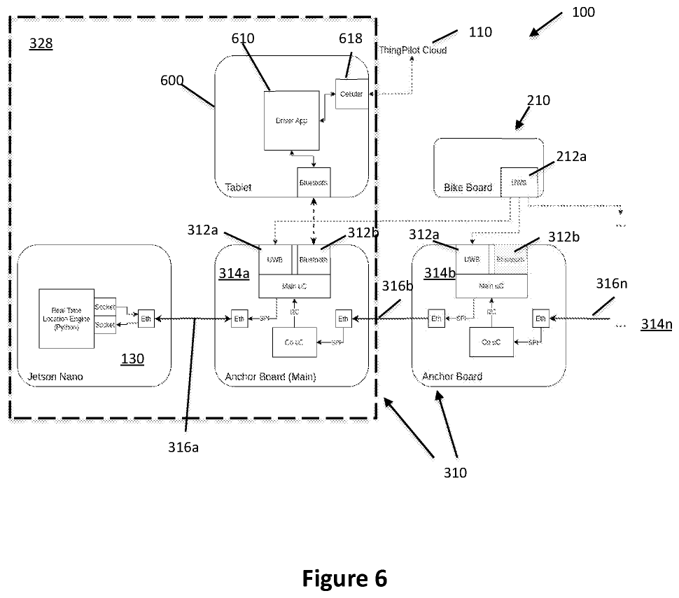

FIG. 6 shows parts of the cycle safety system 100 according to an example. ThingPilot is an example of a cloud-based server 110.

A Bike Board is shown in FIG. 6 as an example of a cycle safety device 210. A transmitter, and in particular a UWB transceiver 212a is operable to advertise its presence by periodic transmission of messages.

A vehicle safety device 310 is operable to receive messages transmitted by the cycle safety device and to use those messages to determine an approximate or likely location of a cycle including the cycle safety device. In the example shown, the vehicle safety device 310 includes an alerting system 328 and a plurality of anchors 314b-314n. The alerting system 328 in this example includes a Jetson Nano as an example processor and local server 130. A tablet 600 is also shown as an example computing device for arrangement in the vehicle 300 as part of the alerting system 328. The tablet may run a Driver App 610. The computing device includes a cellular transceiver 618 operable to use a cellular connection to share information with the cloud-based server 110.

Two Anchor Boards 314a and 314b are depicted in FIG. 6. A plurality of further anchor boards are schematically illustrated as . . . 314n. Each anchor 314 is operable to receive UWB messages from the cycle safety device 210 at a transceiver 312a, to timestamp the received messages, and to pass the timestamped messages on to the local server 130 (shown as the Jetson Nano) for processing. As shown, each anchor 314 may comprise a clock to permit timestamping of signals.

FIG. 6 shows Ethernet connections 316 between the anchors 314, so as to form an anchor chain. At one end of the anchor chain, a first anchor 314a is connected by ethernet cable to the local server 130; for example, a NVidia Jetson Nano as shown. This first anchor 314a may be the ‘lead anchor’. The alerting system 328 is, in this example, in wired (ethernet) communication with the lead anchor 314a, and may be considered as comprising the lead anchor 314a. The lead anchor 314a may have an additional responsibility of acting as a Bluetooth Low Energy (BLE) peripheral, which can be connected to with an application on the computing device, for example on an Android app on a tablet or smartphone. The data that this BLE service provides is:
The relative location of the cycle safety device as x.y coordinates, measured in centimetres. relative to the centre of the motor vehicle;
The status of the motor vehicle's directional indicators (i.e. whether the driver has indicated that a left turn or right turn is approaching or that no direction is being indicated); and
Zone-based location of a cycle from a computer vision system (described below).

The local server 130 has various roles. Firstly, it is responsible for synchronising the clocks on all of the anchors 314, so their timestamped UWB messages can be used by a localisation algorithm. The local server 130 may be configured to correct for the drift and different clock rates across the different anchors 314, as a 1 nanosecond error equates to a potential 300 mm error, which can compound when localising with multiple anchor pairs 314. With synchronised times, the local server 130 may also estimate the location of the cycle safety device 210 relative to the vehicle 300 using a time difference of arrival (TDoA) algorithm. This estimate is passed back to the lead anchor 314 over ethernet.

In order to synchronise the clocks, one of the anchors take the role of lead anchor 314, as selected by the local server 130. In the example shown the lead anchor 314a is comprised as part of the alerting system. but it will be appreciated that another anchor could be selected instead. The lead anchor 314a uses its UWB transceiver 312 not only to receive, but also to send synchronisation messages. These are sent every few hundred milliseconds. As the lead anchor 314a knows what time it sent the message, and all other anchors will know their local time of receiving the synchronisation message, the local server 130 can use these ‘anchor local’ times along with the knowledge of the anchor layout and speed of light to approximate a model of the clocks relative to the clock of the lead anchor 314. This model (which only remains valid for hundreds of milliseconds) can be used to correct the timestamps of the anchors and convert them to ‘lead anchor time’, so they are suitable for use by a TDoA algorithm, for example.

The local server 130 is further responsible for determining the location of a cycle with respect to a vehicle. In particular, the local server applies a TDoA algorithm to the (corrected) timestamped UWB signals received by the anchors 314 from a cycle transmitter 212. For example, if a first receiver ‘A’ receives a signal at time x nanoseconds later than a second receiver ‘B’ receives the signal, the difference in distance from the receivers to a transmitter (such as the cycle transmitter) can be determined based on x. The actual distance between A and the transmitter or B and the transmitter is not determined. Instead, a hyperbolic curve can be calculated that represents possible locations of the cycle transmitter to have given the measured TDoA. By measuring the TDoA with multiple receiver pairs and identifying intersections of the resulting hyperbolas, the possible locations of the cycle transmitter can be reduced and the location of the cycle with respect to the vehicle can be estimated.

The local server 130 is also responsible for identifying and estimating the location of cycles 200 that do not include a cycle safety device 210, using computer vision (described below), as well as monitoring the state of the vehicle's indicators. both of these pieces of information are also sent back to the lead anchor 314a.

The PoE power supply may be insulated or otherwise adapted to reduce thermal output from powering the receiver(s), to improve safety and reduce waste.

Each anchor 314 may comprise a housing and may be attached to the vehicle 300 as described above. The housings may be accessible to allow for repairs and replacement of elements such as the UWB receivers 312a and Bluetooth receivers 312b. The housings may not be accessible without removal from attachment to the vehicle 300, for example, to prevent damage.

Attachment to the vehicle 300 of the receiver housings may be permanent, to prevent receivers 212 from falling off vehicles 300 on the road and potentially causing damage.

The cycle safety system 100 may be used for a fleet of motor vehicles 300, such as HGVs 300. It is envisioned that the initial setup would include a licence to use the app. Each vehicle 300, be that an individual or vehicle 300 in a fleet, may be provided a key for vehicle numbers to be registered on the same licence, for example. The app may allow for an organisation to share information from several cycle safety systems 100, for example.

Using the cycle safety system 100 may include reporting to a cloud-based server 110 and/or physical server 120 and multiple systems 100 may report to the same cloud-based server 110 and/or physical server 120. An organisation may be able to communicate with either server 110, 120, for example via the app, to obtain information about more than one vehicle 300 (and hence, more than one driver). As noted above, the system 100 may include driver monitoring features, which may be accessed by an organisation via the app for example.

The cycle safety system 100 may be used to monitor speed of vehicles 300, for example.

The cloud-based server 110 and/or the physical server 120 may be configured to generate a report including information presented to a driver based on a signal from a transmitter 212, for example, and/or including driver monitoring data. In the case of an accident involving a cycle that included the cycle safety device 210, it may be of interest to an organisation (e.g. an employer of the driver of the vehicle 300) to see whether the driver responded to an alert (via the alert system 328) properly.

The app may allow the organisation to filter information from the cloud-based server 110 or physical server 120 by driver, time or the like.

A global setting across more than one vehicle 300 may be established (for example, via the app) by the organisation, such that the alerting system 328 is configured to indicate to the driver that the vehicle 300 is travelling above a threshold speed. This may be sensed by an accelerometer of the vehicle 300 and the threshold speed may be set by the organisation or may be based on a speed-limit of a road being travelled, for example. This may be in the name of encouraging drivers of vehicles 300 to be safe and thus protect cyclists on the road (even where cyclists do not have the cycle safety device 110 installed on their cycle 200).

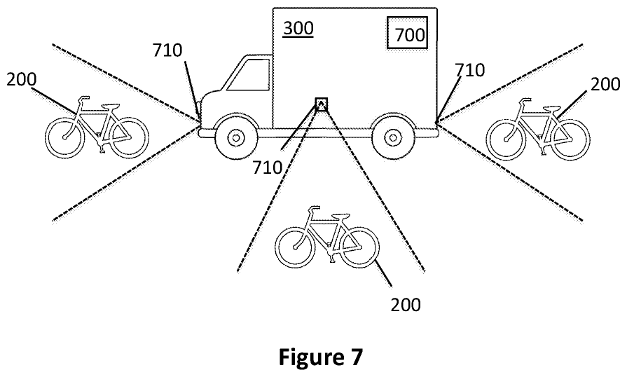

FIG. 7 shows the motor vehicle 300 and shows example possible positions for a camera 710. The cycle safety system 100 may include a computer vision system 700 including one or more cameras 710. Detail of the computer vision system 700 is not shown, but merely schematically illustrated as being associated with the motor vehicle 300.

As shown, the camera 710 may be placed on the front, back, or side of the motor vehicle 300. More than one camera 710 may be used, which may be arranged on different sides of the motor vehicle 300 to obtain different image information as discussed above. Cameras may be useful to the cycle safety system 100 where cycles 200 do not include the cycle safety device 210; the cycles 200 can still be identified and the driver of the motor vehicle 300 can be alerted.

The cycle safety system 100 may employ information from the (or each) camera 710 alongside a transmission from the cycle safety device 210 to provide information to the driver of the motor vehicle 300. Information from each source may be compiled at the processor 130a or local server 130b, at the cloud-based server 110 and/or the physical server 120 to be fed to the driver via the alerting system 328.

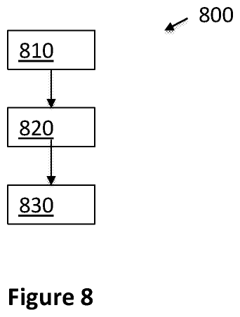

FIG. 8 shows a method 800 of installing the cycle safety device 210 into the cycle 200. The cycle safety device 210 may otherwise be attached to the cycle 200; however, for anti-theft purposes as well as an elegant solution to attaching the device 210 to the cycle 200, the device 210 may be installed inside the cycle 200 (within the frame).

At step 810, the saddle 210 is removed from the seat tube 206. The saddle 210 and seat post 204 may be completely removed from the seat tube 206 to allow access to the inside of the seat post 204 and/or seat tube 206.

The seat post 204 and/or the seat tube 206 may be hollow or include a channel. At step 820, the cycle safety device 210 may be installed into the hollow inside of the seat post 204 or seat tube 206. Example attachment mechanisms are discussed above, which may hold the device 210 in the seat post 204 or seat tube 206.

Once installed, at step 830, the saddle 202 may be replaced. In this way, the cyclist does not need to check that the cycle safety device 210 has not fallen off the cycle 200 during a ride, for example, offering peace of mind. The cycle safety device 210 is disguised from view and so theft of the device 210 is prevented or at least less likely. In addition, the cycle safety device 210 does not affect the appearance of the cycle 200 outwardly-this may be desirable to a cyclist.

Although specific examples have been described, these are not intended to limit the scope of the invention, which should be determined with reference to the accompanying claims.

1. A cycle safety system comprising:
a cycle safety device shaped for insertion into a frame of a cycle, the cycle safety device comprising a transmitter;
a vehicle safety device comprising one or more receivers; and
an alerting system, at least part of the alerting system configured to be positioned adjacent a driver's seat of a motor vehicle,
wherein the transmitter is configured to transmit a signal advertising the presence of the transmitter,
wherein the one or more receivers are configured to receive the signal advertising the presence of a transmitter, and to communicate with the alerting system; and
wherein the alerting system is configured to indicate the presence of the cycle to a driver of the motor vehicle including the vehicle safety system based on the communication from the one or more receivers.

2. The cycle safety system of claim 1, wherein the vehicle safety device comprises a first pair of receivers and a second pair of receivers, wherein each receiver is configured to receive a signal from the transmitter of the cycle safety device and wherein the alerting system is configured to estimate the position of the transmitter by measuring the difference in the time of arrival of the signal at each of the receivers of the first pair and at each of the receivers of the second pair.

3. The cycle safety system of claim 1, wherein the transmitter is an ultra wide band transmitter and wherein the one or more receivers are configured to receive an ultra wide band signal.

4. The cycle safety system of claim 1, wherein the cycle safety device and/or the vehicle safety device is configured to communicate with a cloud-based server, and wherein the alerting system is configured to provide information to the driver of the vehicle based on information from the cloud-based server.

5. The cycle safety system of claim 1, the alerting system comprises a visual indicator which is configured to be positioned within view of the driver of the vehicle, wherein:
the visual indicator comprises a lamp configured to indicate the presence of the cycle based on a signal from the transmitter received at one or more of the receivers and/or
the visual indicator comprises a screen configured to depict the location of the cycle with respect to the vehicle based on a signal from the transmitter received at one or more of the receivers and/or configured to indicate the location of the cycle using words or pictures on the screen based on a signal from the transmitter received at one or more of the receivers.

6. The cycle safety system of claim 1, wherein the alerting system is configured to be positioned within earshot of the driver of the vehicle, and wherein the alerting system comprises a speaker configured to indicate the location of the cycle using sound, based on a signal from the transmitter received at one or more of the receivers.

7. The cycle safety system of claim 4, wherein the vehicle safety device is wired in with a lighting circuit of the motor vehicle, wherein the vehicle safety device is configured to sense when a light is used and wherein the alerting system is configured to base an alert to the driver on use of the light.

8. A cycle safety device for fitting to a cycle, the cycle safety device comprising a transmitter configured to transmit a signal advertising the presence of the transmitter, wherein the cycle safety device is shaped to fit into a frame of the cycle.

9. The cycle safety device of claim 8, wherein the transmitter is an ultra wide band transmitter configured to transmit ultra wide band signals.

10. The cycle safety device of claim 9, further comprising a Bluetooth transmitter configured to transmit Bluetooth signals.

11. The cycle safety device of claim 8, further comprising a motion sensor, wherein the transmitter is configured to enter a powered state when the motion sensor determines that the cycle is moving and wherein the transmitter is configured to enter an unpowered state when the motion sensor determines that the cycle has been stationary for a predetermined period of time.

12. The cycle safety device of claim 8, further comprising a location tracker, wherein the location tracker is configured to transmit its location to a computing device and/or a cloud-based server.

13. The cycle safety device of claim 10, further including a computing device and an application configured to be run on the computing device, wherein the computing device is configured to receive a signal from the Bluetooth transmitter and/or wherein the computing device comprises a motion sensor and/or a location sensor, and/or is configured to receive a signal from a motion sensor and/or a location tracker, wherein the application is configured to present information to the cyclist.

14. The cycle safety device of claims 8, further comprising a receiver configured to receive a signal from a transmitter at the motor vehicle, or the cycle safety device of claim 10 wherein the computing device is configured to receive a signal from a transmitter at the motor vehicle.

15. A method of installing the cycle safety device of claim 8, the method comprising:
removing a saddle and seat post of the cycle from a seat tube of the cycle, such that inner hollow areas of the seat post and seat tube are exposed;
inserting the cycle safety device into the inner hollow area of the seat post or seat tube; and
replacing the saddle on the seat tube such that the cycle safety device is held inside the cycle.

16. A vehicle safety device for fitting to a motor vehicle, for indicating the presence of a cycle to a driver of the motor vehicle, the safety device comprising:
one or more anchors, each comprising a receiver configured to receive a signal from a transmitter within the frame of a cycle;
an alerting system, at least part of which is configured to be positioned adjacent a driver's seat of the motor vehicle, wherein the one or more anchors are configured to communicate with the alerting system and wherein the alerting system is configured to indicate the presence of the cycle to a driver of the motor vehicle based on the communication from the one or more anchors.

17. The vehicle safety device of claim 16, wherein the one or more receivers are configured to receive ultra wide band signals and wherein the transmitter at the cycle is an ultra wide band transmitter.

18. The vehicle safety device of claim 16, wherein the one or more anchors each further comprise a Bluetooth transceiver configured to communicate with the alerting system using a Bluetooth signal.

19. The vehicle safety device of claim 16, wherein the or each anchor comprises a receiver housing including the receiver, the housing being configured for attachment to the motor vehicle, or the vehicle safety device of claim 18, wherein the or each anchor comprises a receiver housing including the receiver and the Bluetooth low energy transceiver.

20. The vehicle safety device of claim 16, further comprising a camera configured to provide image information to the alerting system and/or to a cloud-based server and/or a physical server, wherein the alerting system is configured to indicate the presence of a cycle based on an image captured by the camera.

21. The vehicle safety device of claim 20, further comprising a computer vision system comprising the camera and a computational unit configured to identify a cycle in an image captured by the camera.

22. A cycle comprising the cycle safety device of claim 8.

23. A motor vehicle comprising the vehicle safety device of claim 16.

24. The motor vehicle of claim 23, wherein the motor vehicle is a heavy goods vehicle.

25. The motor vehicle of claim 23, wherein:
(i) one or more anchors are arranged at or proximate the front of the motor vehicle and one or more anchors are arranged at or proximate the back of the motor vehicle, and/or
(ii) the motor vehicle extends a length behind a driver's seat and wherein the motor vehicle comprises one or more anchors at or proximate the centre of the length, and/or
(iii) the motor vehicle comprises one or more anchors on a left side of the motor vehicle and one or more anchors on the right side of the motor vehicle, wherein the left and right sides are distinct from front and back sides of the motor vehicle.
